(19) United States
(12) Patent Application Publication
(10) Pub. No.: US 2024/0334920 A1
(43) Pub. Date: Oct. 10, 2024

(54) INSECT TRAPPING DEVICE AND METHOD

(71) Applicant: Gabriel Parsons, Lansing, MI (US)

(72) Inventor: Gabriel Parsons, Lansing, MI (US)

(21) Appl. No.: 18/131,595

(22) Filed: Apr. 6, 2023

(51) Int. Cl. A01M 1/14

(52) U.S. Cl. CPC A01M 1/145

(57) ABSTRACT

An insect trapping device and method for adhesively securing inserts to a panel by attracting and adhesively securing inserts to a colored panel includes a panel including a first surface, a second surface facing opposite of the first surface, and a perimeter edge. The first and second surfaces of the panel are colored a yellow color and reflecting light attracting insects and having a wavelength from 570 nm to 590 nm. The first surface has a hole extending therethrough and through the second surface. The hole receives a support member such that the panel is hanging from the support member. An adhesive layer is attached to the first surface and adhesively secures insects to the panel when the insects come in contact with the adhesive layer.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to insect traps and more particularly pertains to a new insect trap for attracting and adhesively securing inserts to prevent the insects from harming a plant, including trees.

### (2) Description of Related Art including information disclosed under 37 CFR 1.97 and 1.98.

The prior art relates to insect traps and includes a variety of insect killing and trapping devices being mounted to a support member and adhesively securing insects to an adhesive. Known prior art does not include an insect trap attracting insects by being colored a color reflecting light at a wavelength from 570 nm to 590 nm.

(g) BRIEF SUMMARY OF THE INVENTION

An embodiment of the disclosure meets the needs presented above by generally comprising a panel including a first surface, a second surface facing opposite of the first surface, and a perimeter edge. The first and second surfaces of the panel are colored a yellow color such that it reflects light configured for attracting insects. The first surface has a hole extending therethrough and through the second surface. The hole is configured for receiving a support member such that the panel is hanging from the support member. An adhesive layer is attached to the first surface and is configured for adhesively securing an insect to the panel when the insect contacts the adhesive layer.

Another embodiment of the disclosure comprises a method including the steps of positioning a panel on a limb of a plant. The panel has a first surface and a second surface positioned opposite of each other. The panel has a hole extending therethrough for receiving the limb. The first surface is colored a yellow color configured for attracting insects. The first surface has an adhesive positioned thereon configured to immobilize and retain an insect thereon when the insect comes in contact with the adhesive layer. The panel removes from the limb when a plurality of insects is attached to the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of an insect trapping device and method according to an embodiment of the disclosure.

FIG. 2 is a front view of an embodiment of the disclosure.

FIG. 3 is a bottom isometric view of an embodiment of the disclosure.

FIG. 4 is an in-use view of an embodiment of the disclosure.

### (j) DETAILED DESCRIPTION OF THE INVENTION

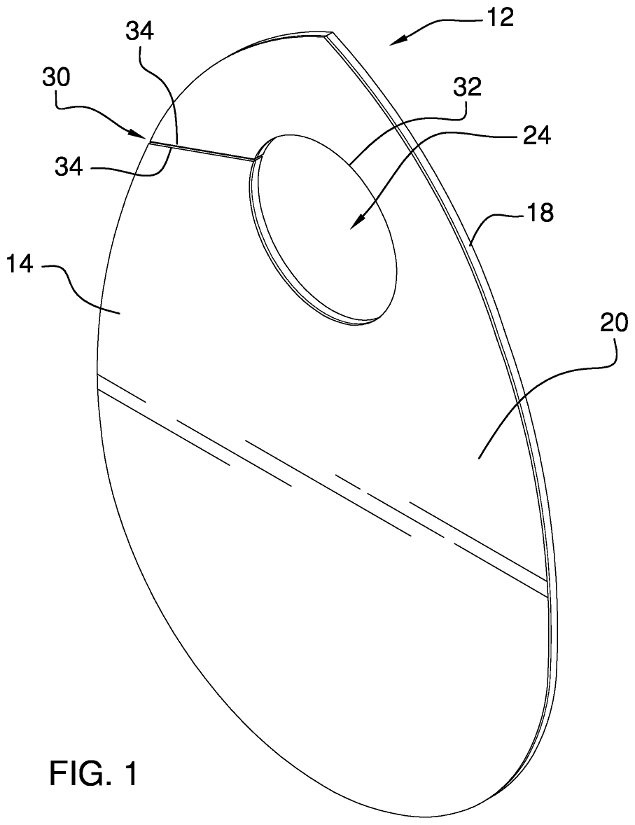

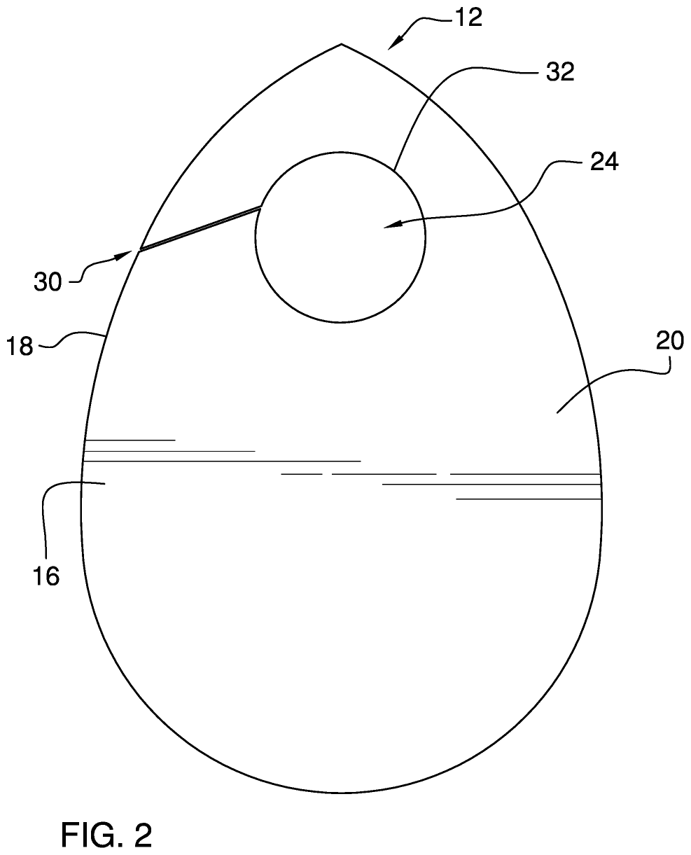

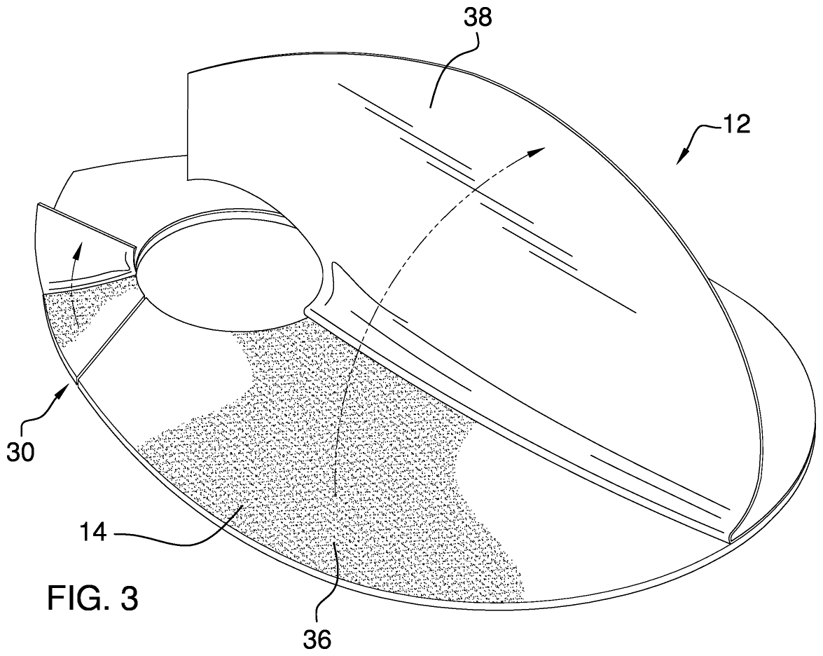

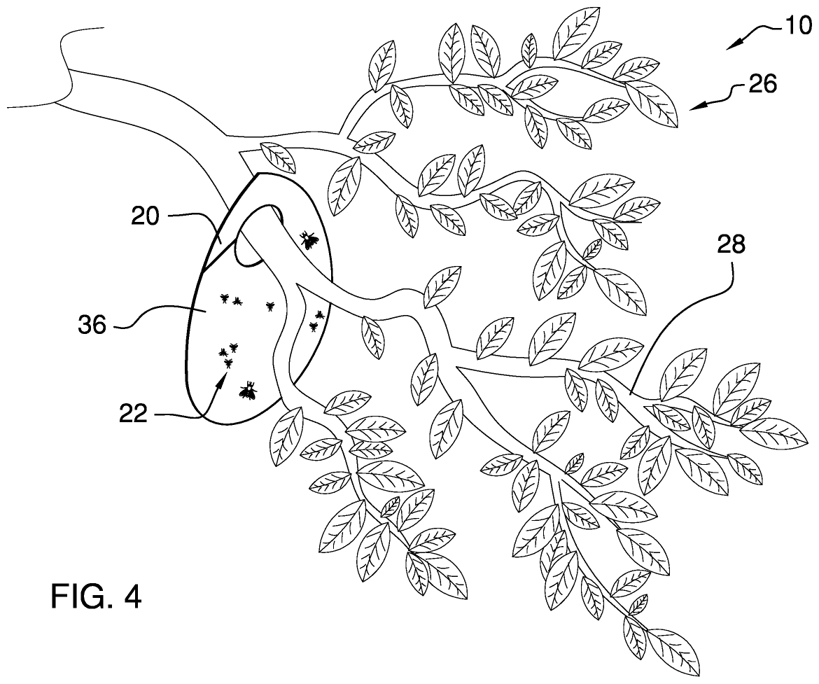

With reference now to the drawings, and in particular to FIGS. 1 through 4 thereof, a new insect trap embodying the principles and concepts of an embodiment of the disclosure and generally designated by the reference numeral 10 will be described.

As best illustrated in FIGS. 1 through 4, the insect trapping device and method 10 generally comprises a panel 12 including a first surface 14, a second surface 16 facing opposite of the first surface 14, and a perimeter edge 18. The first surface 14 and the second surface 16 of the panel 12 are colored a yellow color 20 and reflect light configured for attracting insects 22, such as for example fungus gnats. The yellow light reflected from the panel will typically have a wavelength 24 from 570 nm to 590 nm. Alternatively, the first surface 14 and the second surface 16 may be colored a red color, a blue color, a green color, or any other color reflecting light configured for attracting insects 22.

A hole 26 extends through the first 14 and second 16 surfaces. The hole 26 is configured for receiving a support member 28 such that the panel 12 is hanging from the support member 28. The support member 28 may comprise a limb of a plant 30, a hook mounted to a wall, a door handle, or any other support member 28 in an area prone to having a plurality of insects 22. The hole 26 is positioned proximate to a top end of the panel 12. Alternatively, the hole 26 may be positioned in a center of the panel 12. The perimeter edge 18 has a slit 32 therein that extends through a peripheral edge 33 of the hole 26. The slit 32 forms a pair of parallel edges 34 positioned from the hole 26 to the perimeter edge 18 that are selectively movable away from each other to allow the support member 28 to be extended through the perimeter edge 18 and into the hole 26. The first surface 14 is typically teardrop shaped. Alternatively, the first surface 14 may be diamond shaped, oval shaped, star shaped, or any other geometrical shape.

An adhesive layer 36 is attached to or positioned on the first surface 14 and is configured for adhesively securing insects 22 to the panel 12 when the insects 22 come in contact with the adhesive layer 36. Alternatively, an additional adhesive layer may also be positioned on the second surface 16. The adhesive layer 36 is translucent to facilitate the yellow color 20 of the panel 12 being visible through the adhesive layer 36. Alternatively, the adhesive layer 36 may be colored the yellow color 20. A removable layer 38 is positioned on the adhesive layer 36. The removable layer 38 has an anti-adhesive coating positioned thereon to facilitate removal of the removable layer 38 from the adhesive layer 36. Typically, the adhesive layer 36 will completely cover the first surface 14 of the panel.

In use, the panel 12 is positioned on the limb of the plant 30. The pair of parallel edges 34 of the panel 12 are moved away from each other to allow the limb of the plant 30 to extend into the hole 26. The removable layer 12 is removed from the adhesive layer 36, before or after positioning the panel 12 on the plant 30, to expose the adhesive layer 36. The panel 12 is removed from the limb of the plant 30 when a plurality of insects 22 is attached to the panel 12. Typically, the panel 12 is placed on a plant 30, which may be a houseplant, outdoor plant, tree, bush, or the like, to capture insects that might otherwise damage the plant 30 or which cause a nuisance to people due the plant 30 attracting the insects.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect catching device configured for trapping insects, said insect catching device comprising:
a panel including a first surface, a second surface facing opposite of said first surface, and a perimeter edge, said first and second surfaces of said panel being colored a yellow color and reflecting light configured for attracting insects and having a wavelength from 570 nm to 590 nm, said first surface having a hole extending therethrough and through said second surface, said hole being configured for receiving a support member such that said panel is hanging from the support member; and
an adhesive layer being attached to said first surface and being configured for adhesively securing insects to the panel when the insects come in contact with the adhesive layer.

2. The insect catching device of claim 1, wherein said hole is positioned proximate to a top end of said panel.

3. The insect catching device of claim 1, wherein said perimeter edge has a slit therein that extends through a peripheral edge of said hole, said slit forming a pair of parallel edges positioned from said hole to said perimeter edge that are selectively movable away from each other to allow the support member to be extended into the hole.

4. The insect catching device of claim 1, wherein said first surface is teardrop shaped.

5. The insect catching device of claim 1, wherein the adhesive layer is translucent.

6. The insect catching device of claim 1, further including a removable layer being positioned on said adhesive layer, said removable layer having an anti-adhesive coating positioned thereon to facilitate removal of said removable layer from said adhesive layer.

7. An insect catching device configured for trapping insects, said insect catching device comprising:
a panel including a first surface, a second surface facing opposite of said first surface, and a perimeter edge, said first and second surfaces of said panel being colored a yellow color and reflecting light configured for attracting insects and having a wavelength from 570 nm to 590 nm, said first surface having a hole extending therethrough and through said second surface, said hole being configured for receiving a support member such that said panel is hanging from the support member, said hole being positioned proximate to a top end of said panel, said perimeter edge having a slit therein that extends through a peripheral edge of said hole, said slit forming a pair of parallel edges positioned from said hole to said perimeter edge that are selectively movable away from each other to allow the support member to be extended into the hole, said first surface being teardrop shaped;
an adhesive layer being attached to said first surface and being configured for adhesively securing insects to the panel when the insects come in contact with the adhesive layer, the adhesive layer being translucent; and
a removable layer being positioned on said adhesive layer, said removable layer having an anti-adhesive coating positioned thereon to facilitate removal of said removable layer from said adhesive layer.

8. A method for trapping insects proximate to a plant including the steps of:
positioning a panel on a limb of a plant, the panel having a first surface and a second surface positioned opposite of each other, said panel having a hole extending therethrough for receiving the limb, the first surface being colored a yellow color configured for attracting insects, the first surface having an adhesive positioned thereon configured to immobilize and retain an insect thereon when the insect comes in contact with the adhesive layer; and
removing said panel from the limb when a plurality of insects is attached to the panel.
